(19) United States
(12) Patent Application Publication
(10) Pub. No.: US 2025/0386756 A1
(43) Pub. Date: Dec. 25, 2025

(54) A Linkage System For Mounting An Implement To A Vehicle

(71) Applicant: Patrick Teahan, Castleisland (IE)

(72) Inventor: Patrick Teahan, Castleisland (IE)

(21) Appl. No.: 19/106,584

(22) PCT Filed: Aug. 28, 2023
(86) PCT No.: PCT/EP2023/073540

§ 371 Date: Feb. 25, 2025

(30) Foreign Application Priority Data
Aug. 26, 2022 (GB) 2212433.3

(51) Int. Cl. A01B 59/06; A01G 3/04

(52) U.S. Cl. CPC A01B 59/066; A01G 3/04

(57) ABSTRACT

A linkage system for mounting an implement to a vehicle, the linkage system comprising: a mounting device comprising a support frame and an implement mounting frame, the support frame comprising a vehicle-facing side, an implement facing side and a top support, the implement mounting frame attached on the implement facing side of the support frame for mounting the implement; a hitch link attachment configured to be coupled to the vehicle; characterised by a stabilisation system attached on the vehicle-facing side of the support frame, the stabilisation system comprising at least two stabilising links; and wherein the stabilisation system is configured for coupling between the top support of the support frame of the mounting device and the hitch link attachment via the least two stabilising links.

### CROSS-REFERENCE TO RELATED APPLICATIONS

This application is a U.S. National Stage of International Patent Application No. PCT/EP2023/073540 filed Aug. 28, 2023, which claims priority to United Kingdom Patent Application No. 2212433.3 filed Aug. 26, 2022, both of which are incorporated by reference herein as if reproduced in their entireties.

### FIELD

The present disclosure relates to a linkage system for mounting an implement to a vehicle.

### BACKGROUND OF THE DISCLOSURE

A linkage device may be used to affix an implement to a vehicle such as a tractor, and for raising, lowering or changing the angle of the implement. The implement is usually an agricultural appliance or a soil or ground-working tool. Some examples of such implements include a hedge cutter or the like for modifying hedge contours, blades or the like for modifying ground contours, agricultural implements such as fertilizing, harvesting and cultivating implements including ploughs, harrows, manure spreaders and the like and mowers and the like.

A linkage allows for the position of the implement to be adjusted including to be raised or lowered on the vehicle and the linkage also serves to allow the working height to be adjusted.

Existing linkage designs often use a remote attachment to a three-point connection. While some stabilisation measures may be included in these types of attachments they can be difficult to attach and may not include safe connections to provide a safe part of an implement, such as a hedge cutter. Current remote attachments do not include stabilising links to all relevant connection areas of the implement. Such attachment means do not allow ease of installation or accommodate fixed adjustment of the implement to the required position on the vehicle three-point linkage. Such issues result in a disordered attachment where the differing connections are either not properly fitted or not fitted at all.

While the attached implement such as a hedge cutter may be stable in one direction, its flexibility in dynamic operation may not be noticed thereby leading to misuse during operation and transport. This in some cases could also lead to broken linkages in overstressed points. Existing trailer towing pick up hitch attachments may be used in an attempt to provide stabilisation, but this only works to stabilise in one direction. The above issues may also lead to overstress on the hitch hook which would already be worn due to its main function of towing, for example, a trailer and its integrity for use as a multi force stabilising medium may be affected as a result.

Therefore, there is a need to provide a linkage system that overcomes the drawbacks of existing solutions.

### SUMMARY

The specification and claims provide exemplary arrangements which address the problems noted above associated with the previous imaging systems.

According to a first aspect, there is provided a linkage system (200) for mounting an implement to a vehicle, the linkage system comprising: a mounting device (300) comprising a support frame (310) and an implement mounting frame (350), the support frame (310) comprising a vehicle-facing side (312), an implement facing side (314) and a top support (320), the implement mounting frame (350) attached on the implement facing side (314) of the support frame (310) for mounting the implement; a hitch link attachment (380) configured to be coupled to the vehicle; characterised by: a stabilisation system (360) attached on the vehicle-facing side (312) of the support frame (310), the stabilisation system comprising at least two stabilising links (362-1, 362-2); and wherein the stabilisation system (360) is configured for coupling between the top support (320) of the support frame (310) of the mounting device (300) and the hitch link attachment (380) via the at least two stabilising links (362-1, 362-2).

It has been found that the arrangements of the present disclosure are advantageously capable of being installed to allow side adjustment movement off the vehicle centre line while allowing horizontal position stabilisation of the implement. The system allows the locking of the linkage attachment in this position. The hitch-link attachment connection caters for situations in which forces are being exerted in all directions, such as in the applications described which include forces exerted by the implement mass, and the dynamic usage of the implement. The attachment connection allows stability in frontal, transverse and longitudinal planes.

In one embodiment of the first aspect, the linkage system further comprising at least two lift arms (370-1, 370-2) for coupling to the vehicle.

In one embodiment of the first aspect, each of the lift arms (370-1, 370-2) comprise a straight portion and an angled portion, the straight portion configured for coupling to the support frame (310) and the angled portion configured for coupling to the vehicle.

In one embodiment of the first aspect, the hitch link attachment (380) comprises a tubular shaft (381) adapted to fit within a hitch receiver tunnel of the vehicle and two angled recessed sections (382-1, 382-2) extending from the tubular shaft and adapted to connect to the at least two stabilising links (362-1, 362-2) of the stabilisation system (360).

In one embodiment of the first aspect, the hitch link attachment (380) having a Y shaped configuration, wherein each of the angled sections (382-1, 382-2) of the Y shaped configuration having a recess for receiving a respective stabilising link (362-1, 362-2) and having fixing means for fixing the respective stabilising link (362-1, 362-2) in place within the recess, and wherein a straight section of the tubular shaft (381) comprises a tubular shaft adapted to fit within a hitch receiver tunnel of the vehicle.

In one embodiment of the first aspect, the hitch link attachment (380) is configured for coupling to the vehicle via a hook hitch connection, the hitch link attachment (380) being fixedly secured to the vehicle.

In one embodiment of the first aspect, the hitch link attachment (380) is fixedly secured to the vehicle by a safety pin.

In this way, such configuration of the hitch link attachment advantageously provides a safer alternative to a hook link type device. Towing pick up hitch attachments are often prone to overstress on the hitch hook which may already be worn due to its main function of towing a trailer. By replacing the hitch hook with the hitch link attachment provides a fixedly secure connection of the stabilising links to the vehicle which maintains the integrity for use as a multi force stabilising medium is required. The hitch link attachment provides a simplified changeover from the hitch hook on the vehicle.

In one embodiment of the first aspect, the at least two stabilising links (362-1, 362-2) are adjustable. The at least two stabilising links (362-1, 362-2) may be manually adjustable.

In one embodiment of the first aspect, the stabilisation system (360) is adjustably coupled to the hitch link attachment (380).

In one embodiment of the first aspect, the at least two stabilising links (362-1, 362-2) of the stabilisation system (360) are fixedly secured into a locked position when coupled to the hitch link attachment (380).

In one embodiment of the first aspect, the stabilisation system (360) is configured for coupling between the top support (320) of the support frame (310) of the mounting device (300) and the hitch link attachment (380) via any one of an adjustable screw type connector, a screw type connector, a pin type connector and a rod type connector.

In one embodiment of the first aspect, each of the at least two stabilising links (362-1, 362-2) of the stabilisation system (360) are rotatable attachments, the rotatable attachments being adjustable to the required position so as to effect connection to the implement and the vehicle.

In this way, the configuration allows easily adjustable attachment to a vehicle and a mounting device.

In one embodiment of the first aspect, the top support (320) of the support frame (310) of the mounting device (300) is configured for mating with a top link (330) of the vehicle and a lower support (340) of the support frame (310) of the mounting device (300) is configured for mating with at least two bottom links (370-1, 370-2) of the vehicle.

In one embodiment of the first aspect, the implement mounting frame (350) has a right trapezoidal form.

In one embodiment of the first aspect, the stabilising links (362-1, 362-2) are turnbuckle links and configured to be adjustable in length.

In one embodiment of the first aspect, the angled recessed sections (382) are angled, relative to the tubular shaft (381), by an angle in a range of 30-60 degrees, preferably an angle of 45 degrees.

In one embodiment of the first aspect, the angled sections (382-1, 382-2) are angled, relative to the straight section of the tubular shaft (381), by an angle in a range of 30-60 degrees, preferably an angle of 45 degrees.

In one embodiment of the first aspect, each of the stabilising links (362-1. 362-2), fixedly secured to the support frame (310) and the hitch link attachment (380), are angled relative to the top link (330) or the support frame (310) by an angle of 30-60 degrees, preferably an angle of 45 degrees.

In this way, the linkage system having a stabilisation system and hitch link attachment is configured to provide improved stability in the horizontal or vertical uplift planes. The hitch-link attachment connection and stabilisation system caters for or accommodates forces being exerted in all directions as exerted by the implement mass and the dynamic usage of the implement when connected to the vehicle via the linkage system. In this way, the locking, or securing, and attachment of the stabilising links prevents movement, change in angle, or yaw of the linkage system relative to the vehicle.

In one embodiment of the first aspect, wherein an implement is an integral part of the mounting device (300), the implement and the mounting device (300) forming a unitary structure.

In one embodiment of the first aspect, wherein an implement and the mounting device (300) are secured to one another upon positioning the implement onto the mounting device (300), wherein the implement is secured to the mounting device via any one of a pin, a latch, a screw, a bolt or clamp.

In one embodiment of the first aspect, wherein a first end of each stabilising link (362) is configured to be received on the hitch link attachment (380) and a second end of each link is configured to be received on an attachment member (322) of the top support (320) of the support frame (310); wherein each link is configured to be adjustable such that: when the first end is received and secured in place on the hitch link attachment (380), the link is adjustable in length so as to enable the second end to be received and secured in place on the attachment member (322), or when the second end is received and secured in placed on the attachment member (322), the link is adjustable in length so as to enable the first end to be received and secured in place on hitch link attachment (380).

In this way, the linkage system provides a single system that a user utilizes for mounting an implement to a vehicle. The arrangement enables a user to provide an adjustable connection between the vehicle and the implement through the stabilisation system via the stabilising links and corresponding features of the linkage system to which the links are coupled. This arrangement and configuration of the stabilisation system when connected in place between the vehicle and implement, such as a hedge cutter, provides a secure and stable connection of the implement to a vehicle.

According to a second aspect, there is provided a vehicle, wherein the vehicle is configured to be coupled to a linkage system, according to the specification and claims, and to an implement for cutting vegetation.

In this way, such configuration of the hitch link attachment advantageously provides a safer alternative to a hook link type device when the linkage system is configured to be coupled to the vehicle and to an implement for cutting vegetation. Towing pick up hitch attachments are often prone to overstress on the hitch hook which may already be worn due to its main function of towing a trailer. By replacing the hitch hook with the hitch link attachment provides a fixedly secure connection of the stabilising links to the vehicle which maintains the integrity for use as a multi force stabilising medium when the vehicle is configured to be coupled to the linkage system and to an implement for cutting vegetation. The hitch link attachment provides a simplified changeover from the hitch hook on the vehicle. In this way, there is provided a safe attachment as an integral part of the implement for cutting vegetation.

According to a third aspect, there is provided an implement for cutting vegetation, the implement comprising a linkage system according to the specification and claims, wherein the implement is a hedge cutter.

In this way, the arrangement provides improved stability and safety for the implement. By providing the implement with the linkage system, there is provided a stable and safe arrangement of the implement, for example, during transport and/or use of the implement.

According to a fourth aspect, there is provided a hedge cutter apparatus comprising a hedge cutter and a linkage system according to the specification and claims, wherein the linkage system is coupled to the hedge cutter.

In this way, the arrangement provides improved stability and safety for the hedge cutter apparatus. By providing the hedge cutter apparatus with the linkage system, there is provided a stable and safe arrangement of the hedge cutter apparatus, for example, during transport and/or use of the hedge cutter apparatus.

According to a fifth aspect of the present disclosure, there is provided a system for the purpose of allowing the full safe and easily adjustable attachment via a linkage of a mobile hydraulically mechanical driven hedge cutting machine to a tractor using a standard approved tractor three point linkage. This system can be expanded to other forms of bespoke attachment for a similar purpose. In this way, there is provided a safe attachment as an integral part of the hedge cutter mechanism. As noted above the system can be applied to other tractor drawn or mounted agricultural implements such as fertilizing, harvesting and cultivating implements including ploughs, harrows, manure spreaders and the like, and mowers and the like.

The above aspect provides a linkage system for mounting an implement to a vehicle while providing stabilisation of the implement relative to the vehicle when mounted to the vehicle. This is achieved by the stabilising links and hitch link attachment configuration and their interconnection.

According to a further sixth aspect, there is provided a pick-up hitch link attachment (380) comprising: a tubular shaft (381) adapted to fit within a hook link or hitch receiver tunnel of a vehicle; and one or more attachment elements (500a, 500b) extending from the tubular shaft (381); wherein the one or more attachment element (500a, 500b) is configured for coupling to a stabilising link (362-1, 362-2) of an implement.

The arrangement is advantageously configured such that an implement may be attached at one side only of the tractor hitch—i.e. 500a or 500b depending on the traffic direction or lean requirement for a specific device.

In one embodiment of the sixth aspect, the pick-up hitch link attachment (380) further comprises a distal vehicle coupling portion (388a) and a distal end (388-1) and a proximal implement coupling portion (388b) and a proximal end (388-2), wherein the one or more attachment elements (500a, 500b) are located at the proximal implement coupling portion (388b).

In one embodiment of the sixth aspect, each of the one or more attachment elements (500a, 500b) are configured to receive a stabilising link (362) to provide a stabilised coupling of the implement to the pick-up hitch link attachment and to the vehicle via the hitch link attachment (380).

In one embodiment of the sixth aspect, each one of the one or more attachment elements (500a, 500b) define a receiver (510a, 510b) for coupling of a stabilising link (362) thereto.

In one embodiment of the sixth aspect, the or each attachment element (500a, 500b) is configured to receive a coupling member at the distal or vehicle end of a corresponding stabilising link (362).

In one embodiment of the sixth aspect, the tubular shaft (381) is formed for conformity with a vehicle hitch receiver located on the vehicle.

In one embodiment of the sixth aspect, the tubular shaft (381) is configured to be fixed in location when coupled with the vehicle hitch receiver.

In one embodiment of the sixth aspect, the tubular shaft (381) comprises an aperture (384) for receiving a pin to hold it locked to the vehicle.

In one embodiment of the sixth aspect, the proximal implement coupling portion (388b) comprises a first coupling portion (500a) and/or a second coupling portion (500b), wherein the first coupling portion (500a) comprises a first receiver (510a) and the second coupling portion (500b) comprises a second receiver (510b).

In one embodiment of the sixth aspect, the attachment element (500a, 500b) comprises flanges (582-1, 582-1′, 582-2, 582-2′) arranged extending in a direction rearward of the distal vehicle coupling portion (388a).

In one embodiment of the sixth aspect, the flanges are arranged extending from the distal vehicle coupling portion (388a) by an angle of 30-60 degrees, preferably an angle of 45 degrees.

According to a further aspect there is provided a linkage system (200) for mounting an implement to a vehicle, the linkage system comprising: a hitch link attachment (380) as recited above, the hitch link configured to be coupled to the vehicle; a mounting device (300) comprising a support frame (310) and an implement mounting frame (350), the support frame (310) comprising a vehicle-facing side (312), an implement facing side (314) and a top support (320), the implement mounting frame (350) attached on the implement facing side (314) of the support frame (310) for mounting the implement; characterised by: a stabilisation system (360) attached on the vehicle-facing side (312) of the support frame (310), the stabilisation system comprising at least one stabilising link (362-1, 362-2); and wherein the stabilisation system (360) is configured for coupling between the top support (320) of the support frame (310) of the mounting device (300) and the hitch link attachment (380) via the at least one stabilising link (362-1, 362-2).

As noted above the system can be applied to other tractor drawn or mounted agricultural implements such as fertilizing, harvesting and cultivating implements including ploughs, harrows, manure spreaders and the like, and mowers and the like.

### BRIEF DESCRIPTION OF THE DRAWINGS

The arrangements of the present application will now be described with reference to the accompanying drawings in which:

FIG. 1 is a top view of a vehicle with an implement attached via a three point hitch lift according to the prior art;

FIG. 2 is a plan view of a vehicle with a linkage system according to arrangements of the present specification;

FIG. 3 is a plan view of a vehicle with a linkage system according to arrangements of the present specification;

FIG. 4 is a side elevation view of a vehicle with a linkage system according to arrangements of the present specification;

FIGS. 5a, 5b, 5c and 5d are isometric perspective views of a linkage system according to arrangements of the present specification;

FIG. 6 is a rear front view of the linkage system connection area of FIG. 5a-5d according to the arrangements of the present specification;

FIG. 7 is a plan view of the linkage system of FIG. 5a-5d according to the arrangements of the present specification;

FIG. 8a is an isometric perspective view of the stabilising links, the top link and the hitch link attachment of the system of FIG. 5a-5d according to the arrangements of the present specification;

FIG. 8b is a plan view of the stabilising links, the top link and the hitch link attachment of the system of FIG. 5a-5d according to the arrangements of the present specification;

FIG. 9a is an isometric perspective view of the hitch link attachment of the system of FIG. 5a-5d according to the arrangements of the present specification;

FIG. 9b is a plan view of the hitch link attachment of the system of FIG. 5a-5d according to the arrangements of the present specification.

FIGS. 10 and 1b are the isometric and plan views of the hitch link attachment of FIGS. 9a and 9b with additional structural elements identified;

FIG. 11a is an isometric view of the hitch link attachment of the system, the hitch link attachment having a left side attachment element according to the arrangements of the present specification;

FIG. 11b is an isometric view of the hitch link attachment of the system, the hitch link attachment having a right side attachment element according to the arrangements of the present specification;

FIG. 12 is a rear front view of the linkage system connection area with a hitch link attachment having a single right side attachment element with a single stabilisation link according to the arrangements of the present specification;

FIG. 13a is an isometric perspective view of a single stabilising link coupled to a single attachment element of the hitch link attachment of the system according to the arrangements of the present specification;

FIG. 13b is a plan view of a single stabilising link coupled to a single attachment element of the hitch link attachment of the system according to the arrangements of the present specification.

### DETAILED DESCRIPTION

The present disclosure will be illustrated using the exemplified embodiments shown in the figures. While this disclosure has been shown and described with reference to certain illustrated embodiments thereof, it will be understood by those skilled in the art that various changes in form and details may be made therein without departing from the scope of the disclosure encompassed by the appended embodiments.

The terminology used herein is for the purpose of describing particular embodiments only and is not intended to be limiting of the embodiments of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

The present specification relates to an improved linkage system for mounting an implement to a vehicle. The specification provides an exemplary arrangement for improved linkage systems. It advantageously provides a linkage system that allows side adjustment movement off the vehicle centre line while allowing horizontal position stabilisation of the implement. The system allows the locking of the linkage attachment in this position. Pick-up hitch hook arrangements can be used for connection and to cater for downward forces dependent on the machine mass only. The conventional “ring” and “hook” connection features do not allow stability in the horizontal or vertical uplift planes. The hitch-link attachment connection described below caters for situations in which forces are being exerted in all directions, such as in the applications described which include forces exerted by the implement mass, and the dynamic usage of the implement. The attachment connection allows stability in frontal, transverse and longitudinal planes.

When a vehicle lift arms are arranged in a fully down set position, assistor rams of the vehicle are in a fully relaxed position such that stability is adjustable and maintained with the linkage system. The linkage system allows some level of movement off the vehicle centre line while allowing horizontal position stabilisation of the implement.

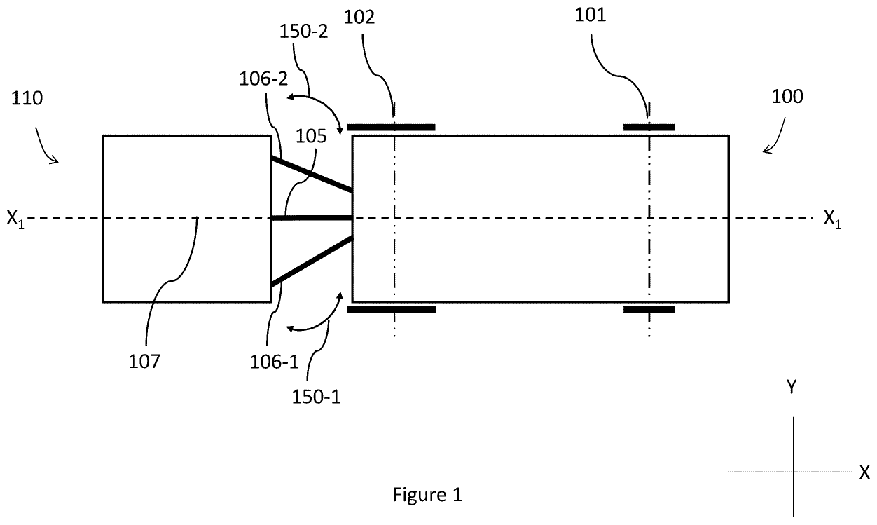

FIG. 1 illustrates a schematic plan view of a vehicle 100 towing an implement 110 according to the prior art. The prior art arrangement being of the form of a three-point hitch lift having an upper link 105, or top link, and two lower links 106-1, 106-2. An implement 110 is attached to the three-point hitch lift. Examples of such implements are grass cutting machinery, vegetation maintenance machinery, hedge cutters, hedge trimmers, grass trimmers and the like. In particular, the implement may be any load bearing machine that may require stability to be maintained during use and transport of the load bearing machine. Examples of such a vehicle is a tractor, however any other suitable vehicle for attaching to an implement can be used. The vehicle and the implement have a longitudinal axis, along the x-axis, oriented in the direction of travel of the vehicle. A central line 107 of the vehicle and the implement along the x-axis is indicated by the line X₁. The vehicle 100 has a front axle 101 and a rear axle 102. Although the implement 110 is shown as connected to the rear of the vehicle 100, the vehicle may have a three-point hitch lift arranged towards the front the vehicle 100 such that the implement 110 is front mounted towards the front of the vehicle. The upper link 105 and two lower links 106-1, 106-2 are configured to couple to the implement 110 and are adjustable in length, where the length may be controlled, for example, electrically or hydraulically so as to align with the implement for coupling/attachment. The lower links 106-1, 106-2 extend in the longitudinal direction from the rear of the vehicle in a V shape configuration as illustrated. The lower links 106-1, 106-2 are adjusted for attaching their distal ends to the implement 110. Located above the lower links 106-1, 106-2 in a vertical direction, transverse to the longitudinal axis, and along the central line 107 between the lower links 106-1, 106-2 is the upper link 105 which extends in a central, longitudinal direction from the rear of the vehicle. The upper link 105 is adjustable and utilized for attaching the distal end to the implement 110. The upper link 105 and the lower links 106-1, 106-2 form the three-point connections of the three-point hitch lift. The proximal ends of each of the upper link 105 and the lower links 106-1, 106-2 are directly connected and coupled to the vehicle. The upper link 105 and the lower links 106-1, 106-2 are adjustable such that adjusting them in the vertical direction, relative to the ground, results in a lowering and raising of the attached implement 110 relative to the ground. During movement, the implement and vehicle arrangement shown is prone to a horizontal relative movement, swivel movement 150-1, 150-2, about the connection between the three-point hitch lift and the implement.

The arrangements of the specification aim to address these issues and to provide an improved stabilised connection by means of the linkage system provided herein.

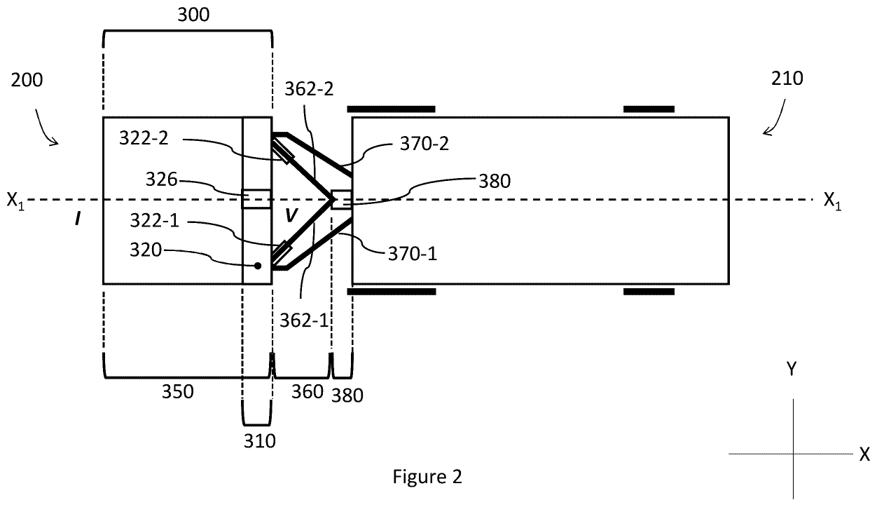

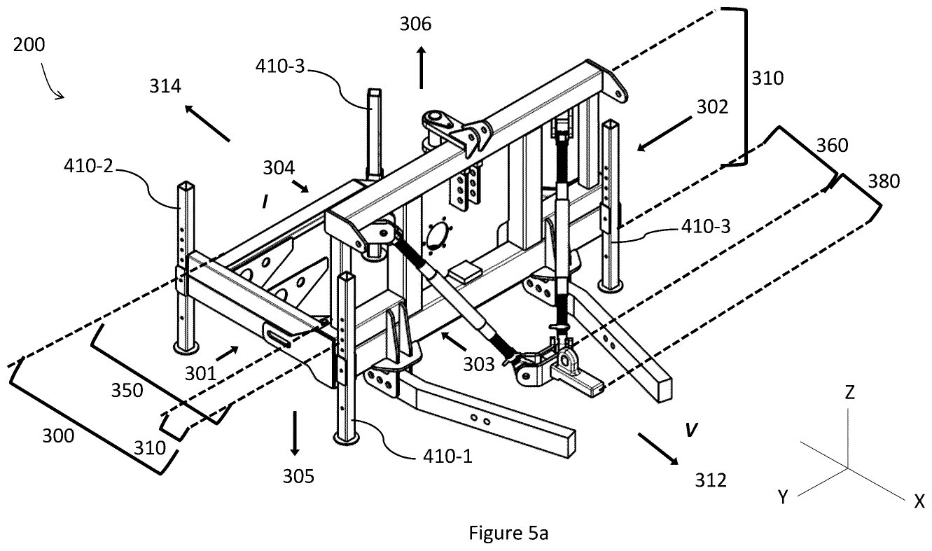

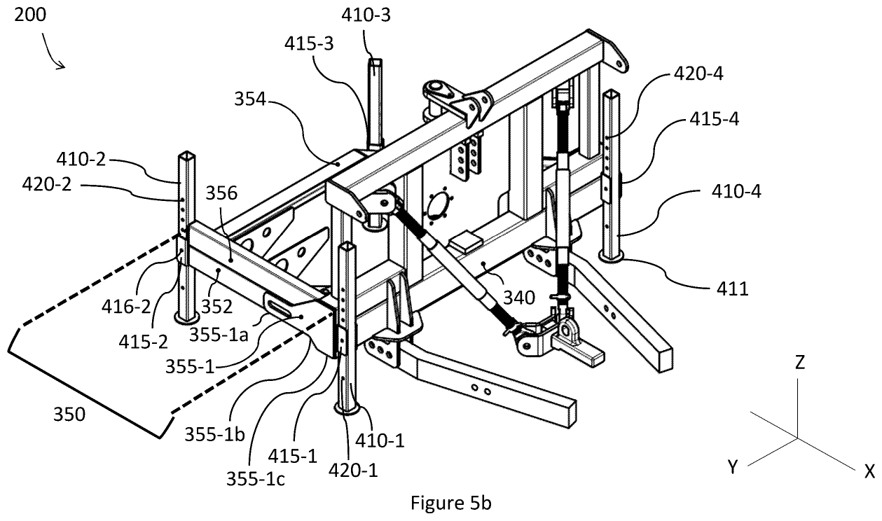

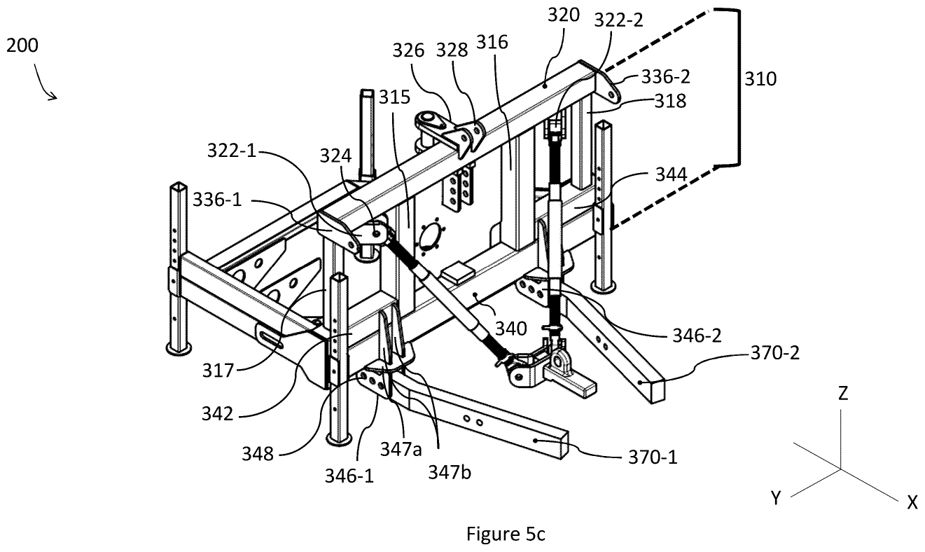

With reference to FIGS. 2 to 4 and FIGS. 5 to 9 key features of the arrangement of the linkage system 200 are described also with reference to the arrangement of the linkage system 200 relative to the vehicle and implement. In effect the linkage system provides for coupling the implement to the vehicle. FIGS. 2 to 4 provide an overview of the arrangement of the linkage system in use and in applications. FIGS. 5 to 9 show details of the linkage system.

FIG. 2 illustrates a schematic plan view of a vehicle 210 and a linkage system 200 for mounting an implement to the vehicle 210 according to an arrangement of the present application. For simplicity and clarity of illustration, the upper link 330 has been removed but similar to the arrangement discussed above for FIG. 1, a three-point hitch lift arrangement is provided having an upper link 330 (not shown) and lower links, or lift arms, 370-1, 370-2.

The linkage system comprises a front vehicle facing side V and a rear implement facing side/and is arranged to extend in a longitudinal direction (X direction) from the portions of the linkage system that are configured to interface with the tractor to those portions of the linkage system that interface with the implement. The longitudinal axis X1 is illustrated.

In one arrangement, the linkage system 200 comprises a mounting device 300, a stabilisation system 360 and a hitch link attachment 380. The mounting device 300 comprises a support frame 310 and an implement mounting frame 350. The hitch link attachment 380 may also be referred to as a pick-up hitch link attachment.

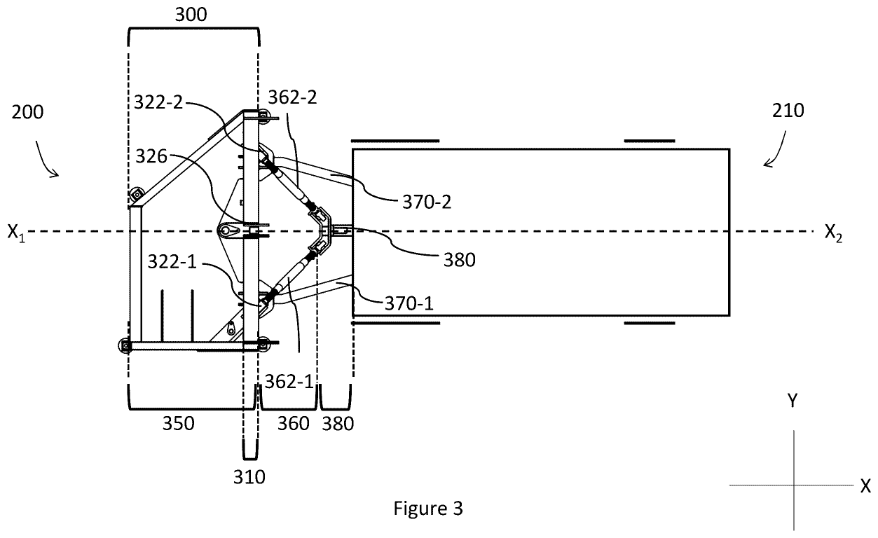

Referring to FIG. 3, a plan view of a linkage system 200 according to an arrangement of the specification is shown. Features of the linkage system 200 are similar to those of the linkage system 200 of FIG. 2 and the same reference numbers have been used where appropriate. The mounting device 300, the support frame 310, the implement mounting frame 350, the stabilisation system 360 and the hitch link attachment 380 are further described below with reference to FIGS. 5-9. In the arrangement shown, the implement mounting frame 350 has a generally right trapezoidal form. However, it will be appreciated that other forms suitable for mounting an implement to the linkage system can be used. For simplicity and clarity of illustration, the upper link 330 of the three point hitch lift has been removed.

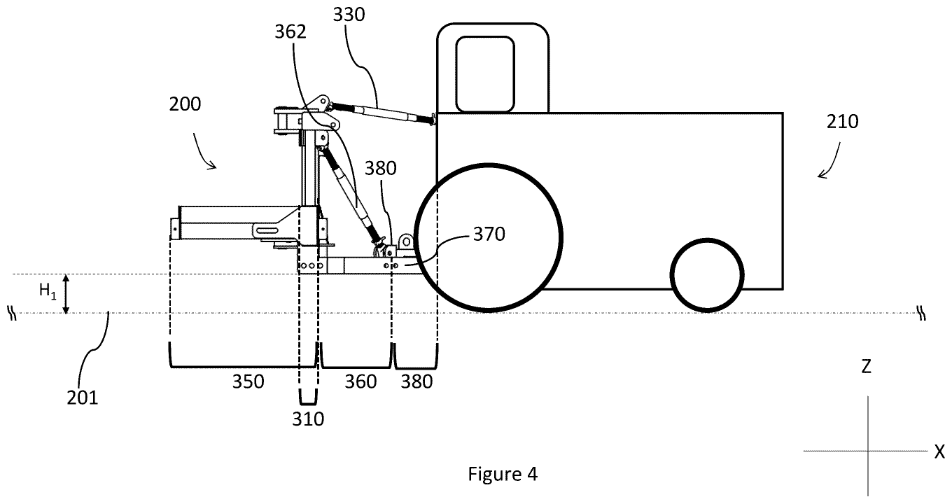

Referring to FIG. 4, a side elevation view of the linkage system 200 coupled to the vehicle 210 according to an arrangement of the specification is shown. Features of the linkage system 200 are similar to those of the linkage system 200 of FIG. 3 and the same reference numbers have been used where appropriate. The upper link 330 and the lift arm(s) 370-1, 370-2 of the three point hitch lift and the stabilising link(s) 362-1, 362-2 of the linkage system 200 are shown when coupled/attached between the support frame 310 of the linkage system 200 and the vehicle 210. The linkage system 200 in the arrangement shown has been raised vertically, in z-direction, relative to the ground 201 by a height H₁. The linkage system 200 is raised by the lift arm(s) 370-1, 370-2 with the upper link 330 and the stabilising link(s) 362-1, 362-2 adjusted in length and fixedly secured in place in their respective attachment elements of the support frame 310, the hitch link attachment 380 and the vehicle 210.

With reference to FIGS. 5 through to 9, the linkage system 200 is described in more detail.

With reference to FIG. 5a, an isometric perspective view of the linkage system 200 according to an arrangement of the specification is shown. Features of the linkage system 200 are similar to those of the linkage system 200 of Figures FIGS. 2 to 4 and the same reference numbers have been used where appropriate. The perspective view shows in further detail the relative positions of the implement mounting frame 350 and the support frame 310 of the mounting device 300, the stabilisation system 360 and the hitch link attachment 380. The perspective view also shows in further detail the relative positions of the lift arms 370-1, 370-2 of the three point hitch lift, the upper link is not shown for ease of viewing but its relative position is shown in Figures further below. The linkage system has a front vehicle facing side 312, V, a rear implement facing side 314, I, a ground facing side 305 and a sky facing side 306. The implement mounting frame 350 of the linkage system is of a trapezoidal form in the x-y plane. The support frame 310 is arranged in a generally vertical plane and extends in the lateral and vertical directions (Y-Z) and the implement mounting frame 350 is arranged in a generally longitudinal plane and extends in the lateral and longitudinal directions (X-Y). The implement mounting frame 350 is arranged to extend longitudinally from a first lateral end 303 to a lateral second end 304 and laterally from the first longitudinal side 301 (left in the drawings) to a second longitudinal side (right) 302. The support frame is arranged to extend vertically from a ground facing end 305 to a sky facing side 306 and from the first longitudinal side 301 (left in the drawings) to a second longitudinal side (right) 302.

The support frame 310 and the implement mounting frame 350 are arranged orthogonal to one another and share a common support member or support bar about the first lateral end 303.

The hitch attachment unit 380 is located a distance away from the support frame 310 and the implement mounting frame 350 towards the vehicle facing side 312. The distance of the hitch attachment unit 380 may be defined by the length of the lifting arms attached to the vehicle and the linkage system 200 and/or the connection of the hitch attachment unit 380 within the hitch link of the vehicle. The distance of the hitch attachment unit 380 from, for example, the first lateral end 303 determines the amount of adjustment required for the stabilising links 362-1, 362-2 of the stabilisation system 360 so as to ensure a secure, fixed, locked arrangement of the stabilisation system 360 to the vehicle via the support frame 310 and the hitch attachment unit 380. The stabilising links 362-1, 362-2 extend from a top support member/bar of the support frame 310 at the first longitudinal side 301 (left in the drawings) and the second longitudinal side (right) 302 in a downward vertical direction towards a central point of the first lateral end 303 to where the stabilising links can be fixedly secured and attached to the hitch link attachment 380 which is spaced apart longitudinally from the support frame 310. The implement mounting frame 350 has a greater extent in the lateral (Y) aspect than the longitudinal (X) aspect. The support frame 310 has a generally rectangular form, however the support frame 310 can have any other shape or form. The support frame 310 has a greater extent in the lateral (Y) aspect than the vertical (Z) aspect.

The linkage system 200 may be provided with support legs 410-1, 410-2, 410-3, 410-4 attached to the linkage system when not in use and detached from the linkage system 200 when in use. The support legs, collectively referred to as 410, provide support for the linkage system when not in use and enables the linkage system to be raised at a height relative to the ground when stored.

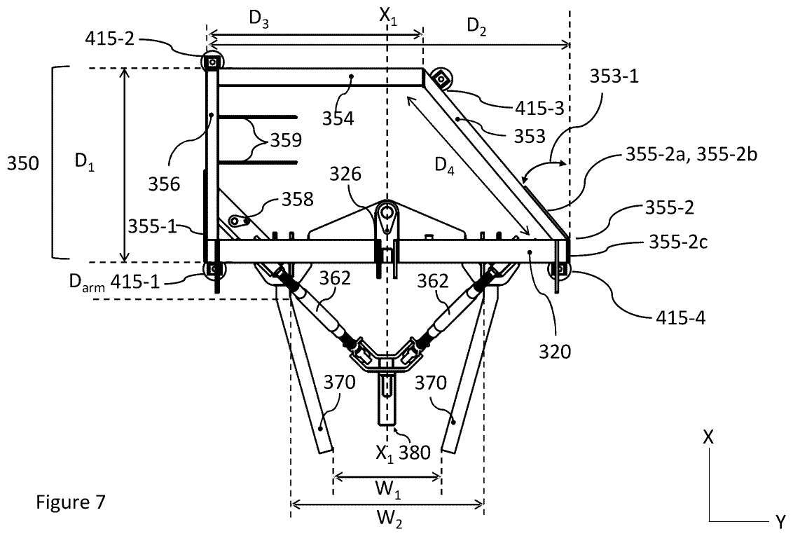

With reference to FIG. 5b and FIG. 7, the isometric perspective view (FIG. 5b) shows in further detail features of the implement mounting frame 350. The implement mounting frame 350 comprises a first support member 352, a second support member 353 (see 353 shown in FIG. 7), the lower support 340 which may also be referred to as a third support member, and a fourth support member 354.

The first support member 352 and the second support member 353 extend longitudinally while the lower support 340 and the fourth support member 354 extend laterally in the x-y plane. An intermediate support member 356 also extends longitudinally from the support frame 310 in the direction of the implement facing side 314. The intermediate support member 356 is coupled to the top surface, sky facing side, of the first support member 352. An end of the intermediate support member 356, vehicle facing end, may be coupled to an intermediate support member 342 (see FIG. 5c) of the support frame 310.

The first support member 352 couples to the lower support 340 and the fourth support member 354 at the first longitudinal side 301 (left in the drawings) and the second support member 353 couples to the lower support 340 and the fourth support member 354 towards the second longitudinal side 302 (right in the drawings). A length of the fourth support member 354 is less than a length of the lower support 340. The second support member 353 therefore forms an angled connection from the lower support 340 to the fourth support member 354, see FIG. 7. The implement mounting frame 350 is therefore of a right trapezoidal form. However, it will be appreciated that the implement mounting frame may be of other forms or shapes suitable for mounting an implement can be used.

Located at the first longitudinal side 301 (left in the drawings) of the lower support 340 is a retention bracket 415-1 and at the second longitudinal side 302 (right in the drawings) of the lower support 340 is a retention bracket 415-4. Located at the implement facing end of the first support member 352 is a retention bracket 415-2. Located at the implement facing end of the second support member 353 is a retention bracket 415-3. The retention bracket 415-1, 415-2, 415-3, 415-4, collectively referred to as 415, are configured for retaining the support legs 410-1, 410-2, 410-3, 410-4 in place. The support legs 410 have a plurality of apertures 420-1, 420-2, 420-3 (not shown), 420-4, collectively referred to as 420, along their longitudinal lengths in the vertical direction, z-direction. The plurality of apertures 420 defining varying heights in the vertical direction, relative to the ground, at which the linkage system 200 may be raised above a ground level. The support legs may held in place within the retention brackets 415 via the aperture 420 by pins, cotter pins and the like. However, it will be appreciated that other suitable brackets and connections for securing, locking and fixing the support legs to the linkage system may be used. For simplicity and clarity of illustration, shown for support leg 410-4 only, each support leg 410 has a base plate 411 with a top surface of the base plate 411 being coupled to the support leg and a bottom surface, ground facing side 305, for contacting a ground or surface so as to support linkage system on the ground when stored away when not in use and to support the linkage system upon connection to a vehicle. The support legs 410 are configured to be removable, or detached from the linkage system such as when the linkage system has been raised in a vertical direction by a distance relative to the ground. In the illustrated arrangements, the base plate 411 is of a circular form but it will be appreciated that other shapes may be used.

Each of the retention brackets 415 may have a u-shaped form. The U-shaped form conforming to the shape of three sides of the support legs 410 such that the support legs can be placed within the u-shaped opening of the retention bracket 415. In other arrangements, the retention bracket may have a shape or form conforming to the shape of the support legs 410 and thus forms an enclosed shape through which the support legs slide into place through the aperture of the enclosed shape. The enclosed shape may be of a square form although other forms may be used depending on the shape and form of the support legs that are retained in the bracket. In the illustrated arrangements, for each bracket 415, the two opposing plates of the bracket, extending away from the supports 352, 353, 340, 354 to which they are attached to, each have an aperture or opening 416 defined therein. For simplicity and clarity of illustration, the opening 416-2 is only shown for bracket 415-2. Brackets 415-1, 415-3 and 415-4 are arranged with openings in a similar manner as 415-2 and 416-2 therefore this aperture 416-2 is shown for bracket 415-2 for simplicity and clarity of illustration. The support leg 410-2 when positioned within the bracket 415-2 is locked or secured in place within the bracket 415-2 by, for example but not limited to, a pin or cotter pin and the like that is placed within the aperture 416-2 of the bracket 415-2 and an aperture 420-2 of the support leg 410-2 that is aligned with the aperture 416-2. However, it will be appreciated that other suitable brackets and connections for securing, locking and fixing the support legs to the linkage system may be used. In this way, the height of the linkage system 200 relative to the ground can be adjusted accordingly.

With reference to FIG. 5c, the isometric perspective view shows in further detail features of the support frame 310. The support frame 310 comprises a top support 320 and a lower support 340. Connected between the top support 320 and the lower support 340 is a first inner support column 315 and a second inner support column 316. A first outer support column 317, adjacent to the first inner support column 315, extends from the top support 320 towards the lower support 340 and a second outer support column 318, adjacent to the second inner support column 316, extends from the top support 320 towards the lower support 340.

A first intermediate support 342 extends from the first inner support column 315 towards the outer support column 317. The first intermediate support 342 extends beyond the outer support column 317 in the y-direction. A bottom surface, ground facing side 305, of the outer support column 317 is connected to a top surface, sky facing side 306, of the first intermediate support 342. A second intermediate support 344 extends from the second inner support column 316 towards the outer support column 318. The second intermediate support 344 extends beyond the outer support column 318 in the y-direction. A bottom surface, ground facing side 305, of the outer support column 318 is connected to a top surface, sky facing side 306, of the second intermediate support 344. Each of the first and second intermediate supports 342, 344 are arranged parallel and in contact with at least a portion of the top surface, sky facing side 306, of lower support 340. The first and second intermediate supports 342, 344 and the outer support column 317, 318 reinforce the support frame and provides a strong and rigid support frame 310 structure.

Located along a central portion of the top support 320 of the support frame 310 is an attachment member 326. The attachment member 326 may be of the form of a bracket. The attachment member is rigidly affixed to the top support 320 of the frame 310. The attachment member 326 is configured for connecting an implement facing end of a top link/upper link 330 (see FIG. 4) of the vehicle to a connection 328 such as, for example but not limited to, pins, cotter pins and the like. However, it will be appreciated that other forms suitable for connecting the upper link 330 to the support frame 310 can be used. The connection 328 may be any suitable quick release connection.

Located on a bottom surface, ground facing end 305, of the top support 320, between the inner support columns 315, 316 and the outer support columns 317, 318 are attachment members 322-1, 322-2. The attachment members may be of the form of a bracket. The attachment member is rigidly affixed to the top support 320 of the support frame 310. The attachment member 322-1, 322-2 are configured for connecting a first end of the stabilising links 362-1, 362-2 of the stabilisation system 360 to a connection 324 such as, for example but not limited to, pins, cotter pins and the like. However, it will be appreciated that other forms suitable for connecting the stabilising links 362-1, 362-2 to the support frame 310 can be used. The connection 324 may be any suitable quick release connection.

Retention brackets 346-1, 346-2 collectively referred to as 346 are each connected along a side surface, at the vehicle facing side, and a bottom surface, at the ground facing side, of the lower support 340 of the support frame 310. The brackets 346 also connect to the side surface, at the vehicle facing side, of the first and second intermediate support member 342, 344. Bracket 346-1 comprises a plate 347a connected to the bottom surface of the lower support 340 and at least two plates 347b spaced apart and orthogonal to the base plate 347a and connected to the vehicle facing side surface of the lower support 340. The plates 347b may be of a triangular form and extend, in the vertical direction, along the vehicle facing side surface of the lower support 340 and the intermediate support member 342. Bracket 346-2 at the second longitudinal side 302 is configured in a similar manner. The plate 347a and the at least two plates 347b provide a secure and rigid connection of the bracket 346 to the support frame 310.

The retention brackets 346 are configured to retain a respective lift arm 370-1, 370-2 in place when connected to the support frame 310. The retention brackets have apertures 348 along their longitudinal lengths through which pins, cotter pins and the like are placed so as to secure and hold the lift arms 370-1, 370-2 in place when located within the retention brackets 346. Each of the retention brackets 346 may have a u-shaped form extending from the plate 347a towards the ground from the ground facing side. The U-shaped form conforming to the shape of three sides of the lift arms 370-1, 370-2 which can be positioned within the u-shaped opening of the retention bracket 346. In other arrangements, the retention bracket may have a shape or form conforming to the shape of the lift arms 370 and thus form an enclosed shape and form through which the lift arms 370 can be slid into place through the aperture of the enclosed shape. In the arrangements illustrated, the shape of the lift arms is of a rectangular form. The brackets have two spaced apart opposing plates that extend away of the bottom surface of the plate 347a towards the ground, each plate has a plurality of apertures or opening 348 defined therein along their longitudinal lengths. For simplicity and clarity of illustration, the apertures is defined for bracket 346-1 only. The lift arm 370-1 when positioned within the bracket 346-1 is locked or secured in place within the bracket 346-1 by, for example but not limited to, a pin or cotter pin and the like that is placed within the aperture 348 of the bracket 346-1 and a corresponding aperture of the lift arm 370-1 (not shown). However, it will be appreciated that other connections and fixings for fixedly securing and locking the lift arms 370-1, 370-2 to the linkage system 200 may be used. At least a portion of one end of the lift arms 370 is thus located and secured within the retention brackets 346.

Located at the first longitudinal side 301 (left in the drawings) of the top support 320 is a first plate 336-1 and at the second longitudinal side 302 (right in the drawings) of the top support 320 is a second plate 336-2. The first and second plates are configured for coupling to a top surface, sky facing side 306, of the support legs 410-1, 410-2. The first and second plates extend longitudinally from the support frame 310 in the direction of the vehicle. The first plate 336-1 and second plate 366-2 when in contact with the top surface of the support legs 410-1, 410-2 provides a bias against the movement of the linkage system in the vertical direction towards the ground. In this way, the bottom of the linkage system is prevented from touching the surface of the ground due to the bias caused by the first plate 336-1 and second plate 366-2 contacting the top surface of the support legs 410-1, 410-2 when, for example, the linkage system is being lowered by the lift arms of the three point hitch lift and the support legs 410-1, 410-2 are positioned within their respective retention brackets 415.

With reference to FIGS. 5b and 5c, a bracket 355-1 (see FIG. 5b) may couple to the first support member 352 of the implement mounting frame 350, the intermediate support member 356 of the implement mounting frame 350, the first intermediate support member 342 of the support frame 310 and the lower support 340 of the implement mounting frame/support frame—the bottom support member is common to both the implement mounting frame 350 and the support frame 310. The bracket 355-1 has an elongated section 355-1a of a same or similar vertical width to that of the first support member 352, a taper section 355-1b that tapers outwards in the vertical direction, z-direction, such that one side of the widest portion of the taper aligns with a top surface of the intermediate support member 356 and the first intermediate support member 342 and the other side of the widest portion of the taper, the ground facing side, aligns with a bottom surface of the lower support 340 of the support frame 310. The bracket 355-1 further comprises another elongated section 355-1c having a width wider than the elongated section 355-1a and aligns with the top surface of the first intermediate support member 342 and the bottom surface of the lower support 340 of the support frame 310.

Although not shown in FIGS. 5b and 5c but identified in FIG. 7, a further bracket 355-2 is provided that couples to the second support member 353, the second intermediate support member 344 and the lower support 340 of the support frame 310. The bracket 355-2 has an elongated section 355-2a having a same or similar width, in the vertical direction, as the second support member 353, a taper section 355-2b (taper not shown) that tapers outwards, with one side of the widest portion of the taper aligning with a top surface the second intermediate support member 344 and the other side of the widest portion of the taper, ground facing side, aligning with a bottom surface of the lower support 340 of the support frame 310. The bracket 355-2 further comprises another elongated section 355-2c (section not shown) having a width wider than the elongated section 355-2a and aligns with the top surface of the the second intermediate support member 344 and the bottom surface of the lower support 340 of the support frame 310. The elongated section 355-2a and the tapered section 355-2b are angled relative to the elongated section 355-2c, such that the angled section conforms to the angle defined by the second support member 353 and the lower support 340 of the support frame 310.

The bracket 355-1, 355-2 may be used so as to provide reinforcement for the connection between the support members 352, 353, the intermediate support member 356, the intermediate support members 342, 344 and the lower support 340 of the support frame 310 thereby providing a rigid, reinforced frame of the linkage system.

With reference to FIG. 5d, the perspective view shows in further detail features of the stabilisation system 360 and the hitch attachment unit 380.

Shown is the hitch link attachment 380 for coupling to a vehicle hitch and the stabilisation system 360. The hitch link attachment 380 is longitudinally spaced apart from the support frame 310 in the direction of the vehicle by a distance X_{hitch}. The distance X_{hitch} may depend on the connection of the hitch link attachment 380 in the hook link of the vehicle and the lengths of the lift arms 370-1, 370-2, collectively referred to as 370, when coupled between the vehicle and the linkage system 200. The hitch link attachment being adjustably positioned within the hook link before being securely fixed in place within the hook link of the vehicle. The lift arms 370-1, 370-2 may be adjusted in height. With the hitch link attachment secured in place on the vehicle and the lift arms 370-1, 370-2 secured in place on the linkage system via the retention brackets 346-1, 346-2 previously described above with reference to FIG. 5c, the stabilisation system 360 can be fixedly secured in place.

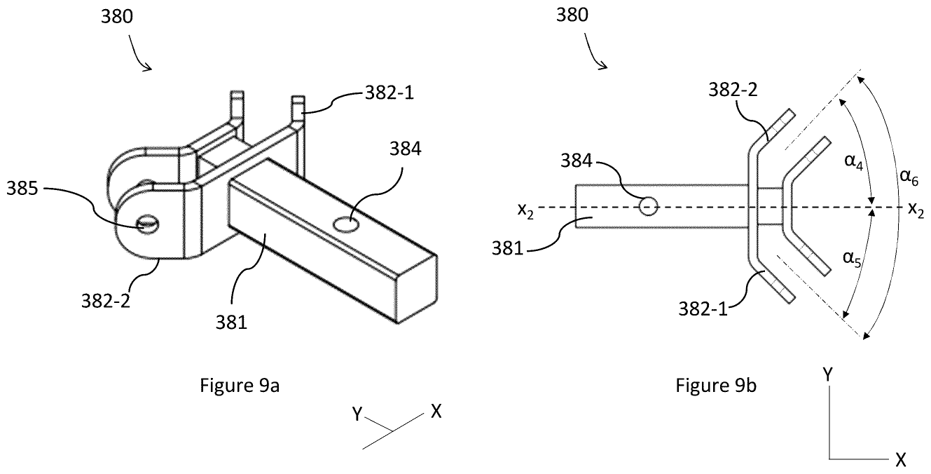

As described, the linkage system 200 is coupled to the vehicle 210 via the three point hitch link. The linkage system 200 is further coupled to the vehicle via the hitch link attachment 380. The hitch link attachment 380 provides a coupling between a vehicle hitch and the stabilisation system 360. To provide this coupling, a hook link of the vehicle is removed and replaced with the hitch link attachment 380. The hitch link attachment attached is configured for locating within a cavity or recess in the hook hitch where the hook link was located. This provides a simple changeover on the vehicle and overcomes issues associated with the use of hook links for implement attachments to the vehicle such as issues of integrity due to wear and tear of the hook link when the vehicle is used to tow machinery and the like. The hitch link attachment 380 comprises at least two attachment elements 382-1, 382-2 for attaching and securing to the stabilising links 362-1, 362-2. The arrangement of the hitch link attachment 380 and the attachment elements is further described below with reference to FIGS. 9a and 9b. In this way, the stabilising links 362-1, 362-2 when fixedly secured and locked in place between the vehicle and the support frame 310 prevent a horizontal relative movement, swivel movement 150-1, 150-2, of the vehicle and implement about the connection between the three-point hitch lift and the implement. However, it will be appreciated that other forms suitable for providing a coupling between a vehicle hitch and the stabilisation system 360 can be used. Other shapes and forms of a hitch link attachment 380 may be required for coupling to a vehicle hitch connection.

In the exemplary arrangement shown, the hitch link attachment 380 comprises a tubular shaft 381 adapted to fit within a hook link or hitch receiver tunnel of the vehicle and at least two attachment elements 382-1, 382-2 (not shown in FIG. 5d but shown in FIG. 9b) extending from the tubular shaft. The at least two attachment elements 382-1, 382-2 are adapted to connect to at least two stabilising links 362-1, 362-2 of the stabilisation system 360. In other arrangements, the hitch link attachment 380 has a Y shaped configuration, wherein each of the attachment elements 382-1, 382-2 of the Y shaped configuration have a recess for receiving respective stabilising links 362-1, 362-2 and having fixing means for fixing the respective stabilising links 362-1, 362-2 in place within the recess. The straight section of the tubular shaft 381 of the Y shaped configuration comprises a tubular shaft adapted to fit within a hitch receiver tunnel or hook link of the vehicle. The attachment elements 382-1, 382-2 connect to the stabilising links 362-1, 362-2 by a connection 385 such as, for example but not limited to, pins, cotter pins and the like. However, it will be appreciated that other forms suitable for connecting the stabilising links to the hitch link attachment can be used. The connection 385 may be any suitable quick release connection. The connection 385 secure and hold the stabilising links 362-1, 362-2 in place when located within attachment elements 382-1, 382-2. The stabilising links 362-1, 362-2 when positioned within the attachment elements 382-1, 382-2 are locked or secured in place within the angled recessed sections 382-1, 382-2 by the connection 385 at the vehicle facing end and an aperture (not shown) of the stabilising links 362.

The stabilisation system 360 is configured for coupling between the top support 320 of the support frame 310 of the mounting device 300 and the hitch link attachment 380 via the least two stabilising links 362-1, 362-2. The stabilisation system 360 is located on the vehicle facing side of the support frame 310. The features of the stabilisation system 360 may be formed integrally with the support frame 310. The stabilising links are adjustable in length. The stabilising links may be manually, electrically or hydraulically adjustable. In this way, when the linkage system is attached to the vehicle via the three point hitch lift, the stabilising links can be adjusted into position to provide a coupling of the linkage system and the vehicle via the stabilisation system.

As described above, at least one end of each of the two stabilising links 362-1, 362-2, are connected to the hitch link attachment 380. The stabilisation system 360 is attached on the vehicle facing side of the support frame 310 at the implement facing ends of each of the two stabilising links 362-1, 362-2. Each of the stabilising links 362-1, 362-2 are attached, at a first end, to the support frame 310 via the attachment elements 322-1, 322-2. The stabilising links 362-1, 362-2 are adjusted into position within the attachment members 322-1, 322-2. The attachment member 322-1, 322-2 are configured for connecting a first end of the stabilising links 362-1, 362-2 of the stabilisation system 360 to a connection 324 such as, for example but not limited to, pins, cotter pins and the like. However, it will be appreciated that other forms suitable for connecting and securing the stabilising links to the support frame 310 can be used. The connection 324 may be any suitable quick release connection.

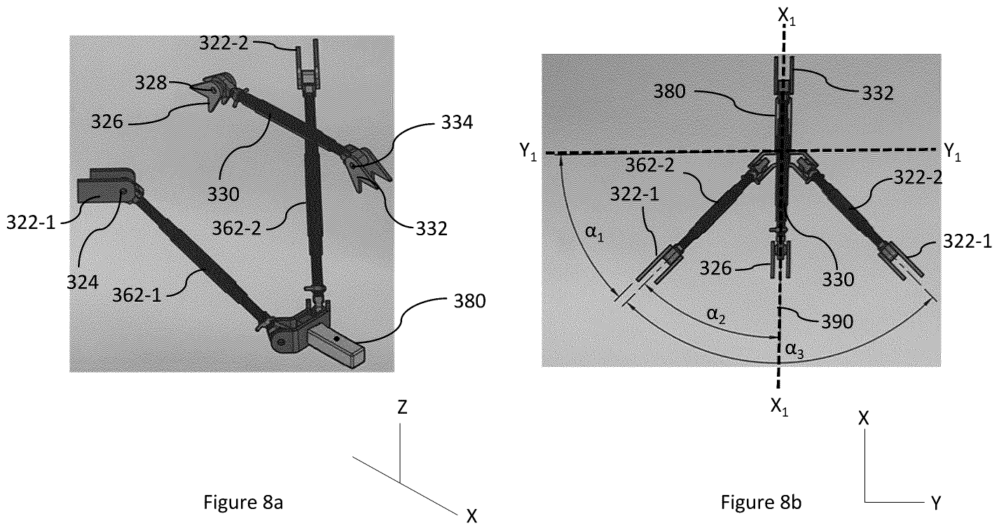

The attachment member 326 is configured for connecting an implement facing end of a top link/upper link 330 (see FIG. 4) of the vehicle to a connection 328 (see FIG. 8a) such as, for example but not limited to, as pins, cotter pins and the like. However, it will be appreciated that other forms suitable for connecting the upper link 330 to the support frame 310 can be used. The stabilising links and the upper link of the exemplary arrangement comprise a turnbuckle, however, it will be appreciated that other suitable arrangement for adjusting the length of the links may be used

In one arrangement, the stabilising links 362 may be configured such that they can be manually adjusted and tightened to suit the geometry of the three point hitch lift when connected to the linkage system 200. The stabilising links 362 may be of the type turnbuckle links and adjustable in length by twisting the link to a length in which each end of the link can be located within the respective connectors 322-1, 322-2 and recessed sections 382-1, 382-2 of the linkage system 200. A protrusion (not shown) may be provided on the stabilising links 362 that is twisted wherein the twisting action, depending on whether it is clockwise or anti-clockwise, either increases or decreases the length of the stabilising link 362. In this way, a section 363 of the stabilising link increases or decreases in length in response to twisting of the protrusion. Although not shown, once the stabilising links 362 have been adjusted to the required length, the stabilising links 362 are locked such that their length is locked so as to avoid the links adjusting due to mechanical movement during operation of the vehicle and implement.

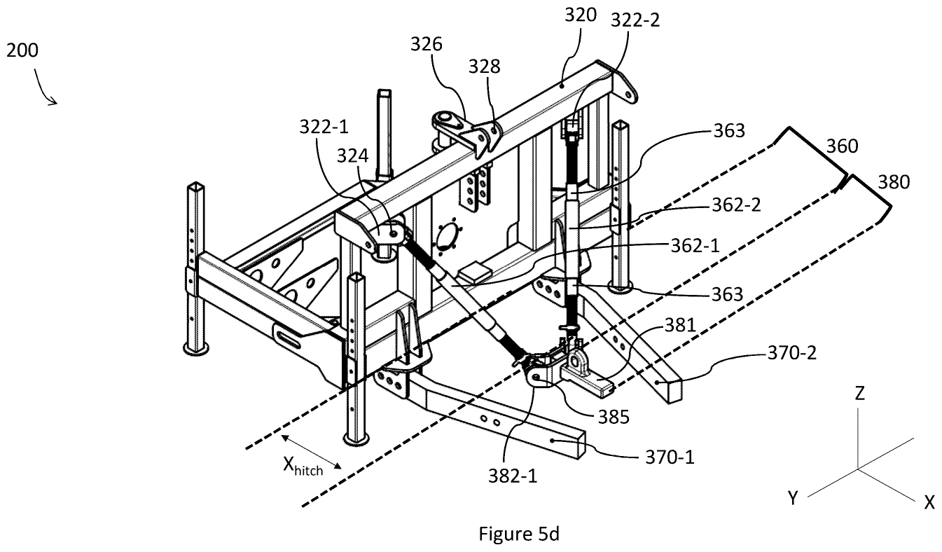

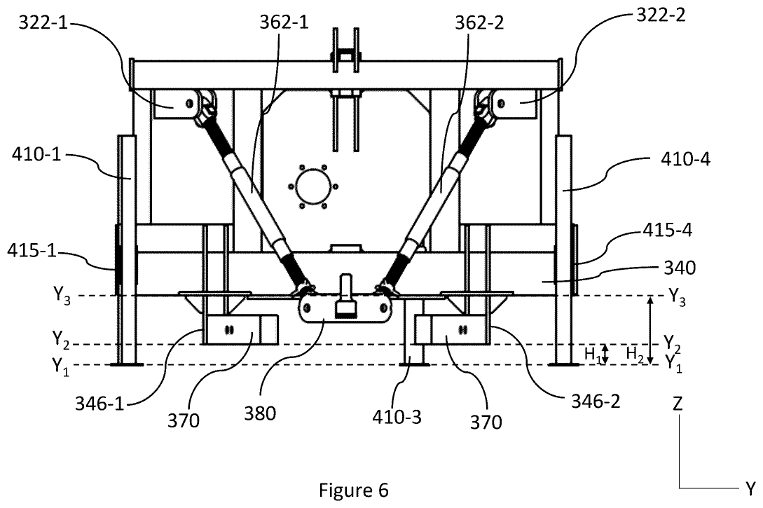

With reference to FIG. 6, the front view shows in further detail features of the stabilisation system 360, the hitch attachment unit 380, the lift arms 370 and the support legs 410. Shown are the stabilising links 362 attached to the top support 320 of the support frame 310 via the attachment members 322-1, 322-2. The stabilising links 362 extend downwardly in the vertical direction towards the ground and the other ends of the stabilising links 362 are attached to the hitch link attachment at a central portion of the support frame 310. Also shown are the support legs 410-1, 410-3, 410-4 attached to their respective retention brackets such that the linkage system is elevated relative to the ground. The ground is defined by the axis Y₁. In the arrangement of the drawing, a bottom surface of the lift arms, defined by axis Y₂, is raised from the ground by a height H₁ and the bottom surface of the lower support 340 of the support frame 310, defined by the axis Y₃, is raised from the ground by a height H₂. When the lift arms 370 of a vehicle are activated in a lifting manner, the arms move in a vertical direction relative to the ground such that the bottom of the linkage system is raised beyond the height H2. When raised by a determined amount, the support legs can be detached from their retention brackets and the implement mounted on the linkage system is used in a stable operable manner when coupled to the vehicle via the stabilisation system 360 and the hitch link attachment 380.

With reference to FIG. 7, the top view shows in further detail features of the stabilisation system 360, the hitch attachment unit 380, the lift arms and the support legs 410. When coupled, or connected to the support frame 310, the lift arms 370 extends longitudinally towards the vehicle from the vehicle facing side of the support frame 310. The lift arms 370 are separated by a width W₂ at the support frame 310. At a distance, defined by Dₐᵣₘ, from the vehicle facing side of the support frame 310, each of the lift arms tapers inwards to a central axis defined by X1 towards the hitch link attachment 380 at which point the lift arms 370 are separated by a width W₁. Where the width W₁ is less than the width W₂. The distal ends of the lift arms are configured for coupling with a vehicle. The distance Dₐᵣₘ may vary depending which of the plurality of apertures 348 of the retention brackets is used to secure the lift arms 370 to the frame 310. In this way, a vehicle having the distal ends of the lift arms attached thereto can approach the linkage system until the lift arms 370 are adjacent to the their respective retention brackets 346 and adjusted so as to fit within the bracket thereby enabling the lift arms 370 to be secured or coupled to the linkage system. Securing the lift arms 370 in place within the retention brackets 346 enables the lifting arms to adjust the height of the linkage system relative to the ground.

The first support member 352 is defined by a length D1, the second support member 353 is defined by a length D4, the lower support 340, not shown but equivalent in length to the top support member shown, is defined by a length D2 and the fourth support member 354 is defined by a length D3. Due to the difference in lengths of D2 and D3, an angled connection 353-1 is formed between the connection of the second support member 353 to the lower support 340 and the fourth support member 354.

FIG. 7 also shows an arrangement in which the attachment member 326 may be further configured to have a shape and form so as to provide a pedestal support for a slewing pin of the implement, such as for example, a hedge cutter arm of a hedge cutter. Also shown is a lower level lock 358, in the form of a lock pin, for securing or affixing, for example, a slewing ram support of an implement such as a hedge cutter. In the arrangement shown, the lock 358 extends, diagonally, from first support member 352 to the lower support 340. In further arrangements, the intermediate support member 356 may have one or more support plates 359 extending therefrom, the support plates 359 configured to provide support for an implement of the mounting device (300), such as but not limited to, providing support for an hydraulic tank of a hedge cutter. However, it will be appreciated that other forms suitable for providing support to portions of an implement can be used.

With reference to FIG. 8a, the isometric perspective view shows in further detail features of the stabilisation system 360 and the hitch attachment unit 380. The arrangement of FIG. 8a has been described above for FIGS. 5c and 5d. Shown are the attachment elements 322-1, 322-2, 326, 332, connections 324, 328, 334, the stabilising links 362-1, 362-2, the hitch link attachment 380, the upper link 330 and its respective attachment element 332 for attaching to the vehicle. Attachment elements 322-1, 322-2, 326 are affixed to a top support 320 of the support frame (not shown) as previously described. The upper link 330 is a vehicle top link and comprises an implement facing end and a vehicle facing end. The implement facing end is configured for connection to the attachment element 326 by a connection 328 such as, for example but not limited to, pins, cotter pins and the like. However, it will be appreciated that other forms suitable for connecting the upper link 330 to the support frame can be used. The vehicle facing end is configured for connection to the attachment element 332 by a connection 334 such as, for example but not limited to, pins, cotter pins and the like. However, it will be appreciated that other forms suitable for connecting the upper link 330 to the vehicle can be used. The connections 324, 328, 334 may be any suitable quick release connectors.

With reference to FIG. 8b, the plan view shows in further detail features of the stabilisation system 360 and the hitch attachment unit 380. FIG. 8b shows a top view of the stabilising links and the upper link 330 when locked into position within their respective attachment elements 322-1, 322-2, 326, 332. The upper link 330 and the hitch link attachment 380 may follow a central line which aligns with a central axis of the vehicle and a central portion of the support frame. A lateral axis is defined by Y₁. When stabilising link 362-1 is secured in place to the support frame and the hitch link attachment, the angle formed from the lateral axis has an angle α1 of 45° and the angle formed from the central, longitudinal axis X₁, has angle α2 of 45°. The angle formed between each of the stabilising links 362-1, 362-1 is defined by α3 and has an angle of 90°. That is, the angle α3 is defined by the sum of the angles formed from each stabilising link relative to the central, longitudinal axis X₁. Each of the stabilising links have a V-shaped form when secured in place between the support frame and the hitch link attachment. Within the exemplary arrangements, while an angle of 45 degrees is described for angle α2, it will be appreciated that other angles in a range of 30-60 degrees, a range of 20-70 degrees, or other suitable angles, may be used.

With reference to FIG. 9a, the isometric perspective view shows in further detail features of the hitch attachment unit 380. The hitch link attachment may have a generally Y shaped form. The straight section of the tubular shaft 381 of the Y shaped configuration comprises a tubular shaft adapted to fit within a hitch receiver tunnel or hook link of the vehicle. The attachment elements, or angled recessed sections, 382-1, 382-2 connect to the stabilising links 362-1, 362-2 by a connection such as, for example but not limited to, pins, cotter pins and the like. The connection is inserted into a connection 385 defined within the angled recessed sections 382-1, 382-2 and a corresponding aperture of the stabilising link 362-1, 362-2 portion inserted within the respective angled recessed sections, 382-1, 382-2 thereby securing the stabilising links 362-1, 362-2 to the hitch attachment unit 380.

With reference to FIG. 9b, the plan view shows in further detail features of the hitch attachment unit 380. As previously discussed above with reference to FIG. 5d, the attachment elements or recessed/angled sections, have an angle α4, α5 of 45° relative to the longitudinal axis, x-direction, defined by axis X₂. The angle α6 of separation from one recessed section 382-1 to the other 382-2 forms an angle of 90°. That is, the angle α6 is defined by the sum of the angles α4 and α5. It will be appreciated that other angles of the hitch link attachment elements 382 suitable for providing a coupling of a vehicle hitch, the stabilisation system 360 and the support frame 310 may be used. Within the exemplary arrangements, while an angle of 45 degrees is described for the angle α4 or α5, it will be appreciated that other angles in a range of 30-60 degrees, a range of 20-70 degrees, or other suitable angles, may be used.

With the stabilising links 362-1, 362-2 fixedly secured within the hitch link attachment 380, the attachment elements ensure a fixed angled connection of the stabilising links 362-1, 362-2 between the hitch link attachment 380 and the support frame 310. It will be appreciated that other forms of the hitch link attachment 380 suitable for providing a coupling between a vehicle hitch and the stabilisation system 360 can be used. Other shapes and forms of a hitch link attachment 380 may be required for coupling to a vehicle hitch connection. The straight section of the tubular shaft 381 of the hitch link attachment may comprise an aperture 384 configured for securing the hitch link attachment 380 within a hook hitch of a vehicle by, for example but not limited to, a pin placed within the aperture 384 and a corresponding aperture of the hook hitch when the hitch link attachment is in place within the hook hitch.

In an exemplary arrangement, a method of attachment of the linkage system is provided. The linkage system may be attached to the vehicle in the following manner. The hook link of the vehicle is removed and replaced with the hitch link attachment 380 within the cavity or recess in the hook hitch where the hook link was located. With the linkage system stored in a position on respective support legs, a vehicle is approached towards the linkage system and the lift arms of the three point hitch lift are positioned under the elevated linkage system, relative to the ground. The lift arms are positioned in proximity to the retention brackets 346 of the linkage system. The lift arms are raised and lifted into position within the retention brackets and fixedly secured in place within the brackets. With the vehicle switched of and the power take off (PTO) fully disengaged from rotation, a universal joint shaft of the PTO is then connected onto the respective splined shaft on the vehicle and the implement-the implement being mounted on the implement mounting frame of the linkage system. With the vehicle switched off and PTO fully disengaged from rotation, an electrical connection plug between the vehicle and the implement is then connected securely. The upper link is then fixedly secured in place between the vehicle and the linkage system via the support frame. The two stabilising links are then inserted and fixedly secured in place on the hitch link attachment. The free ends of the two stabilising links may be rested in place on the lift arms pending connection to the support frame. The linkage system is then raised, a distance from the ground in the vertical direction, by the lift arms. The lift arms may be operated by electrical and/or hydraulic means to raise and lower the arms relative to the ground. The support legs can then be detached from the linkage system. The stabilising links are then fixedly secured to the support frame of the linkage system, the stabilising links may be adjusted in length so as to be coupled to their respective attachment brackets. The stabilising links may be adjusted manually until tight and locked in position while ensuring the upper link centre is in line with the vehicle centre line in its final working position. The alignment may be visually inspected to ensure alignment in place. Once aligned, the linkage system and conversely the implement mounted on the linkage system is in a stabilised position ready for operation.

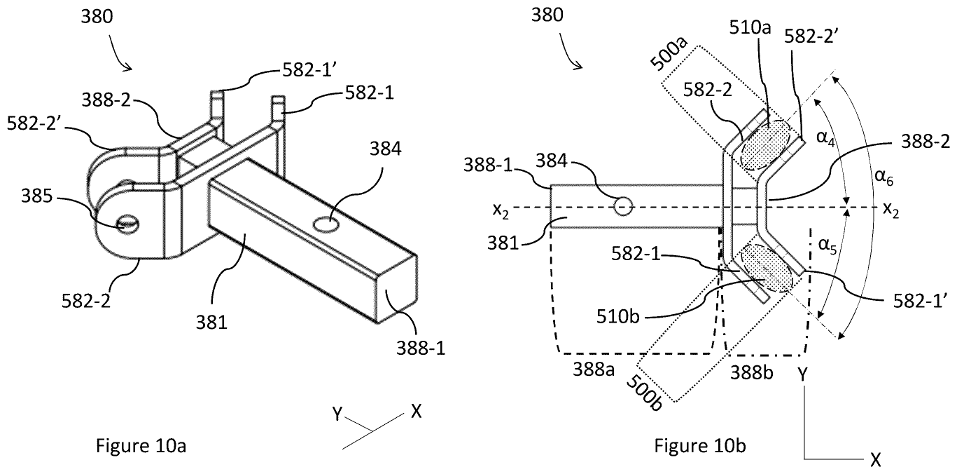

With reference to FIGS. 10a and 10b, the hitch link attachment 380 of FIGS. 9a and 9b are shown comprising a distal vehicle coupling portion 388a and a distal end 388-1 and a proximal implement coupling portion 388b and a proximal end 388-2 with the attachment elements further defined.

The arrangement is advantageously configured such that an implement may be attached at one side only of the tractor hitch—i.e. 582-1 or 582-2 depending on the traffic direction or lean requirement for a specific device. In using this feature the arrangement is configured to advantageously meet the relevant safety requirements, (it is appreciated that description of such requirements is typically included in the relevant manuals). Clearly only approved linkage apparatuses should be used for this “one side only” purpose. The maximum adjustment level as well as the maximum angle of usage would also need to be defined. Differing tractor linkages might have differing connections.

One or more attachment elements 500a, 500b are located at the proximal implement coupling portion 388b. The attachment elements 500a, 500b are configured to receive a stabilising link 362 to provide a stabilised coupling of the implement to the hitch link attachment 380 and to the vehicle via the hitch link attachment. In the exemplary arrangements of FIGS. 10a, 10b, the proximal implement coupling portion 388b of the hitch link attachment 380 comprises two stabilising link attachment elements 500a, 500b each defining a receiver 510a, 510b for coupling of a stabilising link 362 thereto. Each of the two stabilising link attachment elements 500a, 500b may be defined as a first coupling portion 500a and a second coupling portion 500b.

The distal vehicle coupling portion 388a comprises a tubular shaft 381. The tubular shaft 381 is formed for conformity with a vehicle hitch receiver located on the vehicle. The vehicle may be a vehicle and the like for transporting an implement. The tubular shaft 381 is configured to be coupled with a vehicle hitch receiver. The tubular shaft 381 comprises an aperture 384 for receiving a pin to hold it locked to the vehicle.

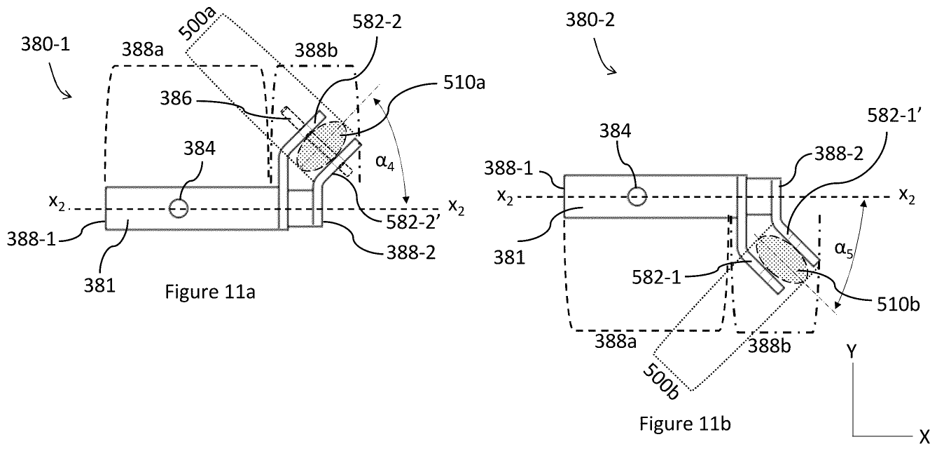

In the FIGS. 11a and 11b, alternative arrangements of hitch link attachments 380-1, 380-2 each having one stabilising link attachment element receiver 510a and 510b, respectively are shown. The Figures illustrate exemplary arrangements tailored for attachment to a stabilising link from the left or right. While the drawings (FIGS. 11 to 13) show for illustrative purposes arrangements having one stabilising link, the illustration is intended to assist in describing the options of the system of the present specification to provide an attachment to the left or right It will be appreciated that a hitch link attachment 380 according to FIGS. 9a, 9b, 10a, 10b may also be provided having left and right stabiliser link attachment elements 500a, 500b but the arrangement allows for one of the left or right only stabiliser link attachment element receivers 510a, 510b to be used for a particular application. Depending on the type of implement to be coupled to the vehicle such as a tractor, one stabilising link may be coupled to one side of the hitch link attachment in some arrangements and depends on requirements and applications. In other arrangements two stabilising links may be coupled to the hitch link attachment, one left and one right.

The or each attachment element receiver 510a, 510b is configured to receive a coupling member at the distal or vehicle end of a corresponding stabilising link 362.

The attachment element receiver 510a comprises flanges 582-1, 582-1′ and the second coupling portion 500b comprises flanges 582-2, 582-2′. The flanges 582-1, 582-1′, 582-2, 582-2′ are arranged extending in a direction rearward of the distal vehicle coupling portion 388a.

The flanges 582-1, 582-1′, 582-2, 582-2′ are arranged extending from the distal vehicle coupling portion 388a by an angle in a range of 30-60 degrees, preferably an angle of 45 degrees.

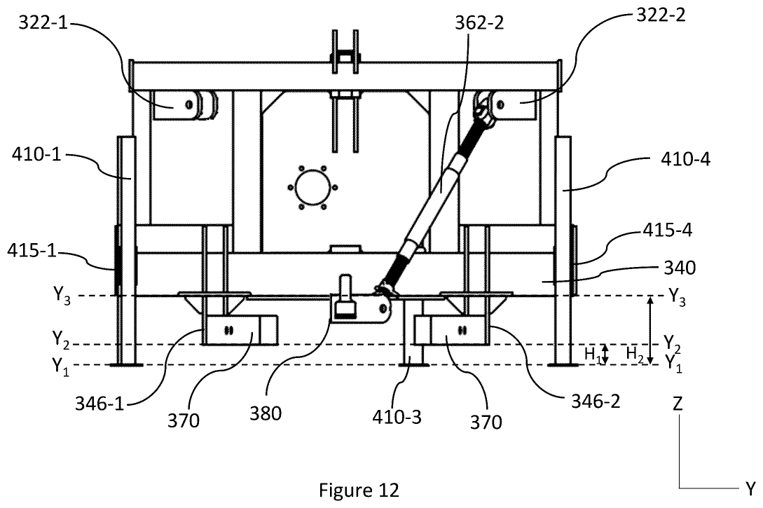

With reference to FIG. 12, illustrated is a front view similar to that of FIG. 6 with a hitch attachment unit 380 having a single coupling portion for receiving a single stabilising links 362-2. It will be appreciated that although a right-side stabilising link 362-2 is shown, a hitch attachment unit 380 having a coupling portion for receiving a stabilising link 362 for a left side can be utilized. The remaining features defined are the same as those as previously discussed for FIG. 6.

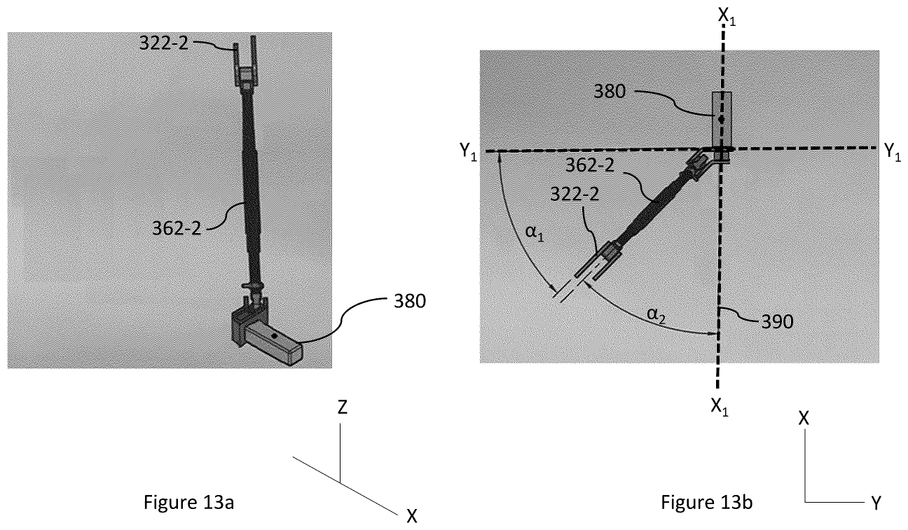

With reference to FIG. 13a, an isometric perspective view similar to that of FIG. 8a shows in further detail features of the stabilisation system 360 having a single stabilising link 362-2 and the hitch attachment unit 380 having a single coupling portion. The arrangement of FIG. 13a has been described above for FIGS. 8a, where FIG. 8a utilized two stabilising links 362-1, 362-2. It will be appreciated that although a right-side stabilising link 362-2 is shown, a hitch attachment unit 380 having a coupling portion for receiving a stabilising link 362 for a left side can be utilized.

With reference to FIG. 13b, the plan view shows in further detail features of the stabilisation system 360 having a single stabilising link 362-2 and the hitch attachment unit 380 having a single coupling portion. FIG. 8b shows a top view of the single stabilising link 362-2 when locked into position within the coupling portion of the respective attachment elements of the hitch link attachment 380. The hitch link attachment 380 may follow a central line which aligns with a central axis of the vehicle and a central portion of the support frame. A lateral axis is defined by Y1. When stabilising link 362-2 is secured in place to the support frame and the hitch link attachment, the angle formed from the lateral axis has an angle α1 of 45° and the angle formed from the central, longitudinal axis X₁, has angle α2 of 45°. Within the exemplary arrangement, while an angle of 45 degrees is described for angle α2, it will be appreciated that other angles in a range of 30-60 degrees, a range of 20-70 degrees, or other suitable angles, may be used.

With reference to FIGS. 3 to 13, the arrangement of the claims and specification provides further advantages over previous implement and vehicle linkage systems. Previous arrangements include those having an implement support and three point hitch lift attachment.

The linkage system according to arrangement of the specification having a stabilisation system 360 and hitch link attachment is configured to provide improved stability in the horizontal or vertical uplift planes. The hitch-link attachment 380 connection and stabilisation system 360 caters for or accommodates forces being exerted in all directions as exerted by the implement mass and the dynamic usage of the implement when connected to the vehicle via the linkage system 200. In this way, the locking, or securing, and attachment of the stabilising links 362-1, 362-2 stops the movement, change in angle, or yaw of the linkage system 200 relative to the vehicle.

The hitch link attachment of the specification advantageously provides a safer alternative to a hook link type device. Towing pick up hitch attachments are often prone to overstress on the hitch hook which may already be worn due to its main function of towing a trailer. By replacing the hitch hook with the hitch link attachment provides a fixedly secure connection of the stabilising links to the vehicle which maintains the integrity for use as a multi force stabilising medium is required. The hitch link attachment 380 provides a simplified changeover from the hitch hook on the vehicle.

In view of the above, the claimed arrangements therefore provide a linkage system for mounting an implement to a vehicle while providing stabilisation of the implement relative to the vehicle when mounted to the vehicle. This is achieved by the stabilising links and hitch link attachment configuration and their interconnection.

It will be understood that the embodiments illustrated above show applications only for the purposes of illustration. In practice, embodiments may be applied to many different configurations, the detailed embodiments being straightforward for those skilled in the art to implement.

1. A linkage system for mounting an implement to a vehicle, the linkage system comprising:
a mounting device comprising a support frame and an implement mounting frame,
the support frame comprising a vehicle-facing side, an implement facing side and a top support,
the implement mounting frame attached on the implement facing side of the support frame for mounting the implement;
a hitch link attachment configured to be coupled to the vehicle;
characterised by:
a stabilisation system attached on the vehicle-facing side of the support frame, the stabilisation system comprising at least two stabilising links; and
wherein the stabilisation system is configured for coupling between the top support of the support frame of the mounting device and the hitch link attachment via the at least two stabilising links.

2. A linkage system according to claim 1, further comprising at least two lift arms for coupling to the vehicle.

3. A linkage system according to claim 2, wherein each of the lift arms comprise a straight portion and an angled portion, the straight portion configured for coupling to the support frame and the angled portion configured for coupling to the vehicle.

4. A linkage system according to claim 1, wherein the hitch link attachment comprises a tubular shaft adapted to fit within a hitch receiver tunnel of the vehicle and two angled recessed sections extending from the tubular shaft and adapted to connect to the at least two stabilising links of the stabilisation system.

5. A linkage system according to claim 1, the hitch link attachment having a Y shaped configuration, wherein each of angled sections of the Y shaped configuration having a recess configured to receive a respective stabilising link and configured to connect the respective stabilising link in place within the recess, and wherein a straight section of a tubular shaft is configured to fit within a hitch receiver tunnel of the vehicle.

6. A linkage system according to claim 1, wherein the hitch link attachment is configured for coupling to the vehicle via a hook hitch connection, the hitch link attachment being fixedly secured to the vehicle.

7. (canceled)

8. A linkage system according to claim 1, wherein the at least two stabilising links are adjustable.

9. (canceled)

10. A linkage system according to claim 1, wherein the stabilisation system is adjustably coupled to the hitch link attachment.

11. A linkage system according to claim 1, wherein the at least two stabilising links of the stabilisation system are fixedly secured into a locked position when coupled to the hitch link attachment.

12. A linkage system according to claim 1, wherein the stabilisation system is configured for coupling between the top support of the support frame of the mounting device and the hitch link attachment via any one of an adjustable screw type connector, a screw type connector, a pin type connector and a rod type connector.

13. A linkage system according to claim 1, wherein each of the at least two stabilising links of the stabilisation system are rotatable attachments, the rotatable attachments being adjustable to the a required position so as to effect connection to the implement and the vehicle.

14. A linkage system according to claim 1, wherein the top support of the support frame of the mounting device is configured for mating with a top link of the vehicle and a lower support of the support frame of the mounting device is configured for mating with at least two lift arms of the vehicle, wherein the top link is a rotatable attachment, the rotatable attachment being adjustable to a required position so as to effect connection to the implement and the vehicle.

15. (canceled)

16. A linkage system according to claim 1, wherein the stabilising links are turnbuckle links and configured to be adjustable in length.

17. A linkage system according to claim 4, wherein the angled recessed sections are angled, relative to the tubular shaft, by an angle in a range of 30-60 degrees, preferably an angle of 45 degrees.

18. A linkage system according to claim 5, wherein the angled sections are angled, relative to the straight section, by an angle in a range of 30-60 degrees, preferably an angle of 45 degrees.

19. A linkage system according to claim 1, wherein each of the stabilising links, fixedly secured to the support frame and the hitch link attachment, are angled relative to the support frame by an angle of 30-60 degrees, preferably an angle of 45 degrees.

20. A linkage system according to claim 1, wherein an implement is an integral part of the mounting device, the implement and the mounting device forming a unitary structure.

21. A linkage system according to claim 1, wherein an implement and the mounting device are secured to one another upon positioning the implement onto the mounting device, wherein the implement is secured to the mounting device via any one of a pin, a latch, a screw, a bolt or clamp.

22. A linkage system according to claim 1, wherein:
a first end of each stabilising link is configured to be received on the hitch link attachment and a second end of each link is configured to be received on an attachment member of the top support of the support frame;
wherein each link is configured to be adjustable such that:
when the first end is received and secured in place on the hitch link attachment, the link is adjustable in length so as to enable the second end to be received and secured in place on the attachment member, or
when the second end is received and secured in placed on the attachment member, the link is adjustable in length so as to enable the first end to be received and secured in place on hitch link attachment.

23.-24. (canceled)

25. A hedge cutting apparatus comprising a hedge cutter and a linkage system according to claim 1, wherein the linkage system is coupled to the hedge cutter.

26. A pick-up hitch link attachment comprising:
a shaft adapted to fit within a hook link or hitch receiver tunnel of a vehicle; and
one or more attachment elements extending from the shaft;
wherein the one or more attachment element is configured for coupling to a stabilising link of an implement.

27. The pick-up hitch link attachment according to claim 26, further comprising a distal vehicle coupling portion and a distal end and a proximal implement coupling portion and a proximal end, wherein the one or more attachment elements are located at the proximal implement coupling portion.

28. The pick-up hitch link attachment according to claim 26, wherein each of the one or more attachment elements are configured to receive a stabilising link to provide a stabilised coupling of the implement to the pick-up hitch link attachment and to the vehicle via the hitch link attachment.

29. The pick-up hitch link attachment according to any one of claim 26, wherein each one of the one or more attachment elements define a receiver for coupling of a stabilising link thereto.

30. The pick-up hitch link attachment according to claim 26, wherein the one or more attachment elements is configured to receive a coupling member at a distal or vehicle end of a corresponding stabilising link.

31.-33. (canceled)

34. The pick-up hitch link attachment according to claim 27, wherein proximal implement coupling portion comprises a first coupling portion and/or a second coupling portion, wherein the first coupling portion comprises a first receiver and the second coupling portion comprises a second receiver.

35. The pick-up hitch link attachment according to claim 26, wherein the attachment elements comprises flanges arranged extending in a direction rearward of a distal vehicle coupling portion.

36. The pick-up hitch link attachment according to claim 35, wherein the flanges are arranged extending from the distal vehicle coupling portion by an angle of 30-60 degrees, preferably an angle of 45 degrees.

37. A linkage system for mounting an implement to a vehicle, the linkage system comprising:
a hitch link attachment according to claim 26, the hitch link attachment configured to be coupled to the vehicle;
a mounting device comprising a support frame and an implement mounting frame,
the support frame comprising a vehicle-facing side, an implement facing side and a top support,
the implement mounting frame attached on the implement facing side of the support frame for mounting the implement;
characterised by:
a stabilisation system attached on the vehicle-facing side of the support frame, the stabilisation system comprising at least one stabilising link; and
wherein the stabilisation system is configured for coupling between the top support of the support frame of the mounting device and the hitch link attachment via the at least one stabilising link.
